(19) United States
(12) Patent Application Publication
(10) Pub. No.: US 2026/0282086 A1
(43) Pub. Date: Sep. 17, 2026

(54) METHOD AND APPARATUS FOR SIDELINK RESOURCE DETERMINATION

(71) Applicant: Lenovo (Beijing) Limited, Beijing (CN)

(72) Inventors: Haipeng Lei, Beijing (CN); Zhennian Sun, Beijing (CN); Xiaodong Yu, Beijing (CN); Xin Guo, Beijing (CN)

(73) Assignee: Lenovo (Beijing) Limited, Beijing (CN)

(21) Appl. No.: 19/473,299

(22) PCT Filed: Apr. 7, 2023
(86) PCT No.: PCT/CN2023/087000

§ 371 Date: Oct. 7, 2025

(51) Int. Cl. H04W 74/0808; H04W 72/25; H04W 74/00

(52) U.S. Cl. CPC H04W 74/0808; H04W 72/25; H04W 74/002

(57) ABSTRACT

Embodiments of the present disclosure relate to methods and apparatuses for sidelink resource determination over an unlicensed spectrum. According to some embodiments of the disclosure, a first user equipment (UE) may: transmit, to a second UE or a BS, a first indicator indicating a first channel access duration or a first contention window size (CWS) for the first UE to perform a channel access procedure on a channel; perform the channel access procedure on the channel before a first slot, wherein the first slot is reserved by the first UE for a sidelink transmission on the channel or the first slot is assigned by the BS to the first UE for the sidelink transmission on the channel; and perform the sidelink transmission on the channel in the first slot in response to the channel access procedure being successful.

### TECHNICAL FIELD

Embodiments of the present disclosure generally relate to wireless communication technology, and more particularly to sidelink resource determination over an unlicensed spectrum.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

A wireless communication system may also support sidelink communications, in which devices (e.g., UEs) that are relatively close to each other may communicate with one another directly via a sidelink, rather than being linked through the BS. The term “sidelink” may refer to a radio link established for communicating among devices (e.g., UEs), as opposed to communicating via the cellular infrastructure (e.g., uplink and downlink). Sidelink transmission may be performed on a licensed spectrum and/or an unlicensed spectrum.

There is a need for handling sidelink transmissions on an unlicensed spectrum.

### SUMMARY

Some embodiments of the present disclosure provide a first user equipment (UE). The first UE may include a transceiver, and a processor coupled to the transceiver. The processor may be configured to: transmit, to a second UE or a BS, a first indicator indicating a first channel access duration or a first contention window size (CWS) for the first UE to perform a channel access procedure on a channel; perform the channel access procedure on the channel before a first slot, wherein the first slot is reserved by the first UE for a sidelink transmission on the channel or the first slot is assigned by the BS to the first UE for the sidelink transmission on the channel; and perform the sidelink transmission on the channel in the first slot in response to the channel access procedure being successful.

In some embodiments of the present disclosure, the first indicator may indicate a value of the first channel access duration from a set of channel access duration values. In some embodiments of the present disclosure, the set of channel access duration values may be in units of microseconds, symbols or slots. In some embodiments of the present disclosure, a size of the first indicator may be dependent on the number of values in the set of channel access duration values.

In some embodiments of the present disclosure, the first indicator may indicate a value of the first CWS from a set of CWS values. In some embodiments, the set of CWS values may include all allowed CWS values for a channel access priority class (CAPC) value associated with the channel access procedure. In some embodiments, the set of CWS values may include all allowed CWS values for all allowed CAPC values.

In some embodiments of the present disclosure, a size of the first indicator may be dependent on the number of values in the set of CWS values. In some embodiments of the present disclosure, a size of the first indicator may be dependent on a maximum number of allowed CWS values for each allowed CAPC value.

In some embodiments of the present disclosure, the first indicator may be transmitted to the second UE. The processor may be further configured to transmit a second indicator indicating the CAPC value associated with the channel access procedure or a priority associated with the sidelink transmission.

In some embodiments of the present disclosure, the first indicator may be transmitted to the second UE via a sidelink control information (SCI) format for reserving the first slot. In some embodiments of the present disclosure, the first indicator may be transmitted to the second UE via a media access control (MAC) control element (CE) carried by a physical sidelink shared channel (PSSCH) scheduled by the SCI format.

In some embodiments of the present disclosure, the first indicator may indicate a value of the first CWS from a set of CWS values, which may include all allowed CWS values for all allowed CAPC values. In some embodiments of the present disclosure, a codepoint of the first indicator may indicate that the channel access procedure to be performed by the first UE is a second type channel access procedure. In some embodiments of the present disclosure, in the case that the first indicator indicates an inapplicable CWS value, the channel access procedure to be performed by the first UE is a second type channel access procedure.

In some embodiments of the present disclosure, the first indicator may indicate an entry of a table, and each entry of the table may indicate a channel access type associated with the channel access procedure. For each entry indicating a first type channel access procedure, a corresponding entry may further indicate a channel access priority class (CAPC) value associated with the first type channel access procedure or both the CAPC value and a CWS associated with the first type channel access procedure.

In some embodiments of the present disclosure, each entry of the table may further indicate cyclic prefix extension (CPE) information associated with the channel access procedure.

In some embodiments of the present disclosure, each CAPC value in the table may be associated with one or more allowed CWSs for a corresponding CAPC value in the table. In some embodiments of the present disclosure, each CAPC value in the table may be associated with a single CWS. In some embodiments of the present disclosure, the single CWS may be a minimum CWS, maximum CWS, or an average CWS among all allowed CWSs for a corresponding CAPC value or a reference CWS for the corresponding CAPC value.

Some embodiments of the present disclosure provide a second UE. The second UE may include a transceiver, and a processor coupled to the transceiver. The processor may be configured to: receive, from a first UE, a first indicator indicating a first channel access duration or a first CWS for the first UE to perform a channel access procedure on a channel before a first slot, wherein the first slot is reserved by the first UE for a first sidelink transmission on the channel; and determine, based on the first channel access duration or a second channel access duration, whether to include one or more consecutive slots preceding the first slot in a candidate resource set for a sidelink transmission associated with the second UE, wherein the second channel access duration is determined based on the first CWS.

In some embodiments of the present disclosure, the first indicator may indicate a value of the first channel access duration from a set of channel access duration values. In some embodiments of the present disclosure, the set of channel access duration values may be in units of microseconds, symbols or slots. In some embodiments of the present disclosure, a size of the first indicator may be dependent on the number of values in the set of channel access duration values.

In some embodiments of the present disclosure, the first indicator may indicate a value of the first CWS from a set of CWS values, which may include all allowed CWS values for a CAPC value associated with the channel access procedure.

In some embodiments of the present disclosure, a size of the first indicator may be dependent on the number of values in the set of CWS values or a maximum number of allowed CWS values for each allowed CAPC value.

In some embodiments of the present disclosure, the processor may be further configured to receive a second indicator indicating the CAPC value associated with the channel access procedure or a priority associated with the first sidelink transmission.

In some embodiments of the present disclosure, the first indicator may be received in an SCI format for reserving the first slot. In some embodiments of the present disclosure, the first indicator may be received in an MAC CE carried by a PSSCH scheduled by the SCI format.

In some embodiments of the present disclosure, the first indicator may indicate a value of the first CWS from a set of CWS values, which may include all allowed CWS values for all allowed CAPC values. In some embodiments of the present disclosure, a codepoint of the first indicator may indicate that the channel access procedure to be performed by the first UE is a second type channel access procedure. In some embodiments of the present disclosure, in the case that the first indicator indicates an inapplicable CWS value, the channel access procedure to be performed by the first UE is a second type channel access procedure.

In some embodiments of the present disclosure, the first indicator may indicate an entry of a table, and each entry of the table may indicate a channel access type associated with the channel access procedure. In some embodiments of the present disclosure, wherein for each entry indicating a first type channel access procedure, a corresponding entry may further indicate a CAPC value associated with the first type channel access procedure or both the CAPC value and a CWS associated with the first type channel access procedure.

In some embodiments of the present disclosure, each entry of the table may further indicate CPE information associated with the channel access procedure.

In some embodiments of the present disclosure, each CAPC value in the table may be associated with one or more allowed CWSs for a corresponding CAPC value in the table. In some embodiments of the present disclosure, each CAPC value in the table may be associated with a single CWS. In some embodiments of the present disclosure, the single CWS may be a minimum CWS, maximum CWS, or an average CWS among all allowed CWSs for a corresponding CAPC value or a reference CWS for the corresponding CAPC value.

In some embodiments of the present disclosure, determining whether to include the one or more consecutive slots preceding the first slot in the candidate resource set may include determining whether the one or more consecutive slots preceding the first slot are within the first or second channel access duration preceding the first slot.

In some embodiments of the present disclosure, the processor may be further configured to receive, from a third UE, a third indicator indicating a third channel access duration or a second CWS for the third UE to perform a channel access procedure on the channel before the first slot, wherein the first slot is reserved by the third UE for a sidelink transmission on the channel. In some embodiments of the present disclosure, determining whether to include the one or more consecutive slots preceding the first slot in the candidate resource set may include determining whether the one or more consecutive slots preceding the first slot are within a maximum duration between the first channel access duration and the third channel access duration preceding the first slot. In some embodiments of the present disclosure, determining whether to include the one or more consecutive slots preceding the first slot in the candidate resource set may include determining whether the one or more consecutive slots preceding the first slot are within a maximum duration between the second channel access duration and a fourth channel access duration preceding the first slot, wherein the fourth channel access duration is determined based on the second CWS.

Some embodiments of the present disclosure provide a BS. The BS may include a transceiver, and a processor coupled to the transceiver. The processor may be configured to: receive, from a first UE, a first indicator indicating a first channel access duration or a first CWS for the first UE to perform a channel access procedure on a channel; transmit, to the first UE, first downlink control information (DCI) scheduling a first slot for the first UE to perform a sidelink transmission on the channel; and leave, based on the first channel access duration or a second channel access duration, one or more time units preceding the first slot blank, wherein the second channel access duration is determined based on the first CWS.

In some embodiments of the present disclosure, the first indicator may indicate a value of the first channel access duration from a set of channel access duration values. In some embodiments of the present disclosure, the set of channel access duration values may be in units of microseconds, symbols or slots. In some embodiments of the present disclosure, a size of the first indicator may be dependent on the number of values in the set of channel access duration values.

In some embodiments of the present disclosure, the first indicator may indicate a value of the first CWS from a set of CWS values. In some embodiments of the present disclosure, the set of CWS values may include all allowed CWS values for a CAPC value associated with the channel access procedure. In some embodiments of the present disclosure, the set of CWS values may include all allowed CWS values for all allowed CAPC values.

In some embodiments of the present disclosure, a size of the first indicator may be dependent on the number of values in the set of CWS values or a maximum number of allowed CWS values for each allowed CAPC value.

In some embodiments of the present disclosure, leaving the one or more time units preceding the first slot blank may include determining whether the one or more time units preceding the first slot are within the first or second channel access duration preceding the first slot.

In some embodiments of the present disclosure, the processor may be further configured to: receive, from a third UE, a third indicator indicating a third channel access duration or a second CWS for the third UE to perform a channel access procedure on the channel, and transmit, to the third UE, a second DCI scheduling the first slot for the third UE to perform a sidelink transmission on the channel. In some embodiments of the present disclosure, leaving the one or more time units preceding the first slot blank may include determining whether the one or more time units preceding the first slot are within a maximum duration between the first channel access duration and the third channel access duration preceding the first slot. In some embodiments of the present disclosure, leaving the one or more time units preceding the first slot blank may include determining whether the one or more time units preceding the first slot are within a maximum duration between the second channel access duration and a fourth channel access duration preceding the first slot, wherein the fourth channel access duration is determined based on the second CWS.

Some embodiments of the present disclosure provide a method performed by a first UE. The method may include: transmitting, to a second UE or a BS, a first indicator indicating a first channel access duration or a first CWS for the first UE to perform a channel access procedure on a channel; performing the channel access procedure on the channel before a first slot, wherein the first slot is reserved by the first UE for a sidelink transmission on the channel or the first slot is assigned by the BS to the first UE for the sidelink transmission on the channel; and performing the sidelink transmission on the channel in the first slot in response to the channel access procedure being successful.

Some embodiments of the present disclosure provide a method performed by a second UE. The method may include: receiving, from a first UE, a first indicator indicating a first channel access duration or a first CWS for the first UE to perform a channel access procedure on a channel before a first slot, wherein the first slot is reserved by the first UE for a first sidelink transmission on the channel; and determining, based on the first channel access duration or a second channel access duration, whether to include one or more consecutive slots preceding the first slot in a candidate resource set for a sidelink transmission associated with the second UE, wherein the second channel access duration is determined based on the first CWS.

Some embodiments of the present disclosure provide a method performed by a BS. The method may include: receiving, from a first UE, a first indicator indicating a first channel access duration or a first CWS for the first UE to perform a channel access procedure on a channel; transmitting, to the first UE, first downlink control information (DCI) scheduling a first slot for the first UE to perform a sidelink transmission on the channel; and leaving, based on the first channel access duration or a second channel access duration, one or more time units preceding the first slot blank, wherein the second channel access duration is determined based on the first CWS.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2-4 illustrate examples of sidelink transmissions in accordance with some embodiments of the present disclosure;

FIGS. 5-7 illustrate flow charts of exemplary procedures for sidelink communications in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

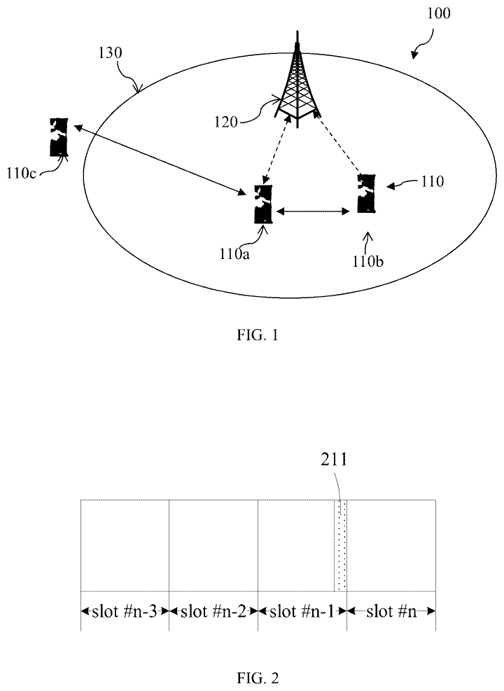

FIG. 1 illustrates a schematic diagram of a wireless communication system 100 in accordance with some embodiments of the present disclosure.

As shown in FIG. 1, wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a, UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1).

Sidelink transmission may involve a physical sidelink control channel (PSCCH) and an associated physical sidelink shared channel (PSSCH), which is scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE). The PSSCH may carry data which may require corresponding hybrid automatic repeat request acknowledgement (HARQ-ACK) feedback from the Rx UE(s) to the Tx UE. The HARQ-ACK feedback for a PSSCH may be carried on a physical sidelink feedback channel (PSFCH).

Various resource allocation modes (e.g., resource allocation mode 1 and resource allocation mode 2) may be supported for a sidelink transmission. Resource allocation mode 1 is based on the scheduling of a BS. Resource allocation mode 2 is based on the autonomous selection of a UE. The specific definitions of the two modes are described in 3GPP specifications.

For example, in resource allocation mode 1, resources may be assigned by a BS via dynamic scheduling or a configured grant. For example, a BS may transmit a physical downlink control channel (PDCCH) (e.g., downlink control information (DCI)) to a UE to schedule a sidelink resource(s) for the UE. The UE may then inform another UE(s) about the resource(s) it will use to transmit a PSSCH.

For example, in resource allocation mode 2, a UE may need to perform resource sensing by monitoring and decoding all SCIs transmitted in a sidelink resource pool to obtain resource reservation information. By doing so, the UE may identify candidate resources that are available for communication. The UE may then, for example, randomly select required resources from the identified candidate resources.

In some embodiments of the present disclosure, sidelink transmission may be performed on an unlicensed spectrum. This is advantageous because a sidelink transmission over an unlicensed spectrum can achieve, for example, an increased data rate(s). In order to achieve fair coexistence between various systems, for example, NR systems (e.g., NR-U systems) and other wireless systems, a channel access procedure, also known as a listen-before-talk (LBT) test, may be performed before communicating on the unlicensed spectrum. When the channel access procedure is successful, a UE can start transmission on the channel and occupy the channel a certain channel occupancy time (COT). Otherwise, the UE cannot start the transmission and may continue to perform another channel access procedure until a successful result.

Various types of channel access procedure (e.g., Type 1 channel access procedure and Type 2 channel access procedure as specified in 3GPP specification) may be supported when communicating on the unlicensed spectrum.

For example, for a Type 2 channel access procedure, the LBT duration may be 16 us or at least 25 us. Therefore, the LBT duration can be confined within one symbol for 15 kHz or 30 kHz subcarrier spacing (SCS) or may be longer than one symbol for 60 kHz or larger SCS.

For example, for Type 1 channel access procedure, a UE cannot predict when the channel access procedure initiated by the UE will be successfully completed since a random backoff counter is generated within a contention window (CW) and the contention window size (CWS) is variable according to HARQ-ACK feedback for a PSSCH transmitted in the reference duration. This may cause a problem for resource selection.

For example, on one hand, a UE (denoted as UE #1 for simplicity) cannot determine whether one or more consecutive slots immediately followed by a slot which has been reserved by another UE (denoted as UE #2 for simplicity) can be selected or included in a candidate resource set for sidelink transmission associated with UE #1 or not. This is because UE #1 cannot determine how long the channel access duration is required for UE #2 to perform a Type 1 channel access. UE #2 also does not have such priori information before the completion of the corresponding channel access procedure. In that sense, UE #1 cannot know how many slots before the reserved slot are unavailable for resource selection.

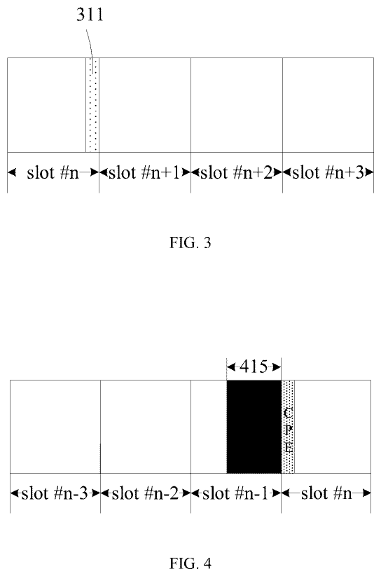

For example, referring to FIG. 2, assuming that slot #n is reserved by UE #2, there are several cases for UE #1 to determine whether slot #n−1 can be included in the candidate resource set:
Case A1: slot #n is in a COT initiated by another UE (e.g., UE #3) and shared to UE #2, then a Type-2 channel access procedure can be performed by UE #2 (e.g., in gap 211) and slot #n−1 can be included in the candidate resource set by UE #1;
Case 2: slot #n is within an ongoing COT of UE #2 and continued to be used by UE #2 after a pause, then a Type-2 channel access procedure can be performed by UE #2 (e.g., in gap 211) and slot #n−1 can included in the candidate resource set by UE #1;
Case 3: UE #2 intends to initiate a COT since slot #n, then a Type-1 channel access procedure is required by UE #2 and whether slot #n−1 can be included in the candidate resource set by UE #1 depends on the LBT duration required by UE #2. For example, assuming that a slot includes 14 symbols and a slot is not used for sidelink transmission if the number of available symbols in this slot is smaller than 6, when the number of symbols required for the LBT (i.e., Type-1 channel access procedure performed by UE #2) is larger than 8, no sidelink transmission is transmitted in slot #n−1. UE #1 should not include slot #n−1 in its candidate resource set. Furthermore, when the number of symbols required for the LBT is larger than 22, no sidelink transmission is transmitted in both slot #n−2 and slot #n−1. UE #1 should not include slot #n−2 and slot #n−1 in its candidate resource set. In some cases, even slot #n−3 may not be available for UE #1 when a longer LBT duration is required.

Hence, UE #1 cannot know the LBT duration required by UE #2 to access slot #n and cannot determine whether to include slot #n−1 and even a slot(s) before slot #n−1 in the candidate resource set for UE #1.

On the other hand, a UE (denoted as UE #1′ for simplicity) cannot know whether one or more consecutive slots immediately after a slot which has been reserved by another UE (denoted as UE #2′ for simplicity) can be selected or included in a candidate resource set or not, for sidelink transmission associated with UE #1′ or not. This is because UE #1′ cannot know how long the channel access duration is required for itself to perform a Type 1 channel access procedure. In that sense, UE #1′ can't know how many slots after the reserved slot are unavailable for resource selection.

For example, referring to FIG. 3, assuming that slot #n is reserved by UE #2′, there are several cases for UE #1′ to determine whether slot #n+1 can be included in the candidate resource set:
Case B1: slot #n+1 is included in a COT initiated by UE #2′ or any other UE and can be shared to UE #1′, then a Type-2 channel access procedure can be performed by UE #1′ (e.g., in gap 311) and slot #n+1 can be included in the candidate resource set by UE #1′;
Case B2: slot #n is within an ongoing COT initiated by UE #1′ and continued to be used by UE #1′ in slot #n+1, then a Type-2 channel access procedure can be performed by UE #1′ (e.g., in gap 311) and slot #n+1 can be included in the candidate resource set by UE #1′;
Case B3: UE #1′ intends to initiate a COT since slot #n+1, then a Type-1 channel access procedure is required and whether slot #n+1 can be included in the candidate resource set by UE #1′ depends on the LBT duration required by UE #1′. For example, assuming that a slot includes 14 symbols and a slot is not used for sidelink transmission if the number of available symbols in this slot is smaller than 6, when the number of symbols required for the LBT (i.e., Type-1 channel access procedure performed by UE #1′) is larger than 8, no sidelink transmission is transmitted in slot #n+1. UE #1′ should not include slot #n+1 in its candidate resource set. Furthermore, when the number of symbols required for the LBT is larger than 22, no sidelink transmission is transmitted in both slot #n+1 and slot #n+2. UE #1′ should not include slot #n+1 and slot #n+2 in its candidate resource set. In some cases, even slot #n+3 may not be available for UE #1′ when a longer LBT duration is required.

Hence, UE #1′ cannot know the LBT duration required by UE #1′ to access slot #n+1 and cannot determine whether to include slot #n+1 and even a slot(s) after slot #n+1 in the candidate resource set.

Embodiments of the present disclosure provide solutions to solve the above issues. For example, solutions for facilitate resource selection for sidelink transmission on an unlicensed spectrum are proposed. The proposed solutions can not only solve the above issues, but also avoid high implementation complexity at a UE or a BS and increase spectrum utilization efficiency. More details on the embodiments of the present disclosure will be illustrated in the following text in combination with the appended drawings.

In some embodiments of the present disclosure, a UE may transmit, to another UE or a BS (depending on the resource allocation mode employed), information associated with a channel access procedure to be performed by the UE for accessing a channel, so as to facilitate the resource selection of the another UE or resource assignment of the BS. On the other hand, the UE can also use such information for resource selection. Such information may include a channel access duration or a CWS for the UE to perform the channel access procedure on the channel.

For example, in some embodiments of the present disclosure, when resource allocation mode 1 is employed, a UE (e.g., a Tx UE, denoted as UE #A1 for simplicity) may transmit information associated with a channel access procedure to be performed by UE #A1 to a BS. For example, when UE #A1 requests a resource for a sidelink transmission over an unlicensed spectrum, a (possible) channel access duration which may be required for accessing the channel is reported to the BS. When the BS assigns a slot (e.g., slot #n) for UE #A1 (e.g., scheduling slot #n via a DCI or configured grant for UE #A1 to perform a sidelink transmission on the channel), the BS should leave one or more time units (e.g., a number of symbols or slots) preceding slot #n blank so as to ensure that UE #A1 may access slot #n. For example, the one or more time units may be within or not shorter than the reported channel access duration.

For example, referring to FIG. 4, UE #A1 may indicate channel access duration 415 to the BS. The BS should leave the time units (e.g., one or more symbols in the example of FIG. 4) preceding slot #n within channel access duration 415 blank. For example, no UE transmits on the channel during channel access duration 415 preceding slot #n.

Various methods may be employed for implementing the report of the (possible) channel access duration to the BS. For example, UE #A1 may transmit an indicator (denoted as indicator #A1 for simplicity) indicating the channel access duration to the BS. Indicator #A1 may be transmitted in layer 1 (L1) signaling or via higher layer signaling such as a media access control (MAC) control element (CE) or radio resource control (RRC) signaling.

For example, indicator #A1 may indicate a value of the channel access duration from a set of channel access duration values. The size of indicator #A1 (e.g., the number of bits for indicator #A1) may be dependent on the number of values in the set of channel access duration values. For example, the size of indicator #A1 may be equal to ┌log₂ N┐, where N is the number of values in the set of channel access duration values.

Various methods may be employed for implementing the set of channel access duration values. For example, the set of channel access duration values may be in units of microseconds, symbols or slots. For example, the set of channel access duration values may be {25 us, 34 us, 43 us, 52 us, 61 us, 70 us, 100 us, 140 us, 210 us, . . . }, {0 symbol, 1 symbol, 2 symbols, 4 symbols, 7 symbols, . . . }, or {0 slot, 1 slot, 2 slots, 4 slots, . . . }. Indicator #A1 may indicate one value among the set of channel access duration values.

In some embodiments of the present disclosure, the BS may assign slot #n for a plurality of UEs (e.g., UE #A1 and UE #A1′) for sidelink transmissions. For example, the BS may transmit, to UE #A1 and UE #A1′, separate DCIs or configured grants scheduling slot #n for UE #A1 and UE #A1′ to perform sidelink transmissions on the channel (e.g., via frequency division multiplexing (FDM)). The BS may determine the maximum channel access duration among the plurality of UEs and leave one or more time units (e.g., a number of symbols or slots) preceding slot #n blank based on the maximum channel access duration, so as to ensure that the plurality of UEs may access slot #n. For example, each of UE #A1 and UE #A1′ may report a channel access duration (e.g., via indicator #A1) to the BS. The BS may determine the maximum channel access duration among the reported channel access durations. The one or more time units may be within or not shorter than the maximum channel access duration.

For example, in some embodiments of the present disclosure, when resource allocation mode 1 is employed, a UE (e.g., a Tx UE, denoted as UE #B1 for simplicity) may transmit information associated with a channel access procedure to be performed by UE #B1 to a BS. For example, when UE #B1 requests a resource for a sidelink transmission over an unlicensed spectrum, a CWS which is to be used for accessing the channel is reported to the BS. When the BS assigns a slot (e.g., slot #n) for UE #B1 (e.g., scheduling slot #n via a DCI or configured grant for UE #B1 to perform a sidelink transmission on the channel), the BS should determine a (possible) channel access duration, for example, based on the reported CWS and leave one or more time units (e.g., a number of symbols or slots) preceding slot #n blank so as to ensure that UE #B1 may access slot #n. For example, the one or more time units may be within or not shorter than the determined channel access duration.

In some embodiments, the BS may determine the channel access duration (e.g., channel access duration 415 in FIG. 4) based on the reported CWS. For example, when a Type-1 channel access procedure is to be used by UE #B1, the channel access duration may be determined or estimated based on the reported CWS and other necessary information such as the CAPC or the priority associated with the channel access procedure to be performed by UE #B1. The “priority associated with the channel access procedure” may also be referred to as the “priority associated with a sidelink transmission,” which is performed by a UE in response to the corresponding channel access procedure being successful. For example, each (allowed or supported) sidelink transmission priority may correspond to an (allowed or supported) CAPC. For example, the BS may estimate the channel access duration required by UE #B1 based on the equation of (16+mₚ*9+9*M′) in unit of microseconds, where M′ denotes the reported CWS and mₚ is based on the CAPC.

In some embodiments, when a Type-2 channel access procedure is to be used by UE #B1, the BS may determine or estimate the channel access duration required by UE #B1 based on the sensing interval of a Type-2 channel access procedure (e.g., >=25 us, =16 us, or <16 us).

Various methods may be employed for implementing the report of the CWS to the BS. For example, UE #B1 may transmit an indicator (denoted as indicator #B1 for simplicity) indicating the CWS to the BS. Indicator #B1 may be transmitted in L1 signaling or via higher layer signaling such as an MAC CE or RRC signaling.

In some embodiments of the present disclosure, indicator #B1 may indicate a value of the CWS from a set of CWS values. In some embodiments, the set of CWS values may include all allowed CWS values for a CAPC value associated with the channel access procedure. In some embodiments, the set of CWS values may include all allowed CWS values for all allowed CAPC values.

In some embodiments, the size of indicator #B1 (e.g., the number of bits for indicator #B1) may be dependent on the number of values in the set of CWS values. For example, the size of indicator #B1 may be equal to ┌log₂ K┐, where K is the number of values in the set of CWS values. In some embodiments, the size of indicator #B1 (e.g., the number of bits for indicator #B1) may be dependent on the maximum number of allowed CWS values for each allowed CAPC value.

For example, Table 1 below shows a mapping between CAPC values and allowed CWS values (i.e., “allowed CWₚ sizes” in the table). CW_{min,p} and CW_{max,p} in the table respectively refer to the minimum and maximum CWSs of a corresponding CAPC. The definition of my is specified in 3GPP specifications. Such table may be configured for a UE or predefined, for example, in a standard(s). It should be understood that Table 1 is only for illustrative purposes, and should not be construed as limiting the embodiments of the present disclosure.

TABLE 1
mapping between CAPC values and allowed CWSs

| Channel | | | | |
|---|---|---|---|---|
| Access | | | | |
| Priority | | | | |
| Class | | | | |
| (p) | mₚ | CW_{min, p} | CW_{max, p} | allowed CWₚ sizes |
| 1 | 2 | 3 | 7 | {3, 7} |
| 2 | 2 | 7 | 15 | {7, 15} |
| 3 | 3 | 15 | 1023 | {15, 31, 63, 127, 255, 511, 1023} |
| 4 | 7 | 15 | 1023 | {15, 31, 63, 127, 255, 511, 1023} |

According to Table 1, for CAPC value 1, 2 CWPs (i.e., 3 and 7) can be employed; for CAPC value 2, 2 CWPs (e.g., 7 and 15) can be employed; and for CAPC values 3 and 4, 7 CWPs (e.g., 15, 31, 63, 127, 255, 511, and 1023) can be employed. For all allowed CAPC values (e.g., 1-4), 9 CWPs (e.g., 3, 7, 15, 31, 63, 127, 255, 511, and 1023) can be employed.

In some examples, according to Table 1, the set of CWS values may include {3,7} for CAPC value 1, {7,15} for CAPC value 2, or {15,31,63,127,255,511,1023} for CAPC value 3 and CAPC value 4. In some examples, the size of indicator #B1 may be 1 bit (i.e., ┌log₂ 2┐) for both CAPC value 1 and CAPC value 2, and 3 bits (i.e., ┌log₂ 7┐) for both CAPC value 3 and CAPC value 4. Therefore, the number of required bits for indicating the CWS (e.g., the size of indicator #B1) can be variable according to the CAPC value associated with the channel access procedure to be performed. For example, when CAPC value 1 is employed, indicator #B1 may include 1 bit, where bit value “0” may indicate a CWS of 3 and bit value “1” may indicate a CWS of 7; or vice versa.

In some examples, regardless of the CAPC value associated with the channel access procedure to be performed, 3 bits can be used to indicate one CWS for each of the 4 CAPC values. That is, the size of indicator #B1 may be 3 bits (i.e., ┌log₂ max (2, 2, 7, 7)┐), which is based on the maximum number (e.g., max (2, 2, 7, 7)) of allowed CWS values for each allowed CAPC value. For example, indicator #B1 may include 3 bit, where bit value “000” may indicate a CWS of 3 when CAPC value 1 is employed, a CWS of 7 when CAPC value 2 is employed, or a CWS of 15 when CAPC value 3 or 4 is employed; bit value “001” may indicate a CWS of 7 when CAPC value 1 is employed, a CWS of 15 when CAPC value 2 is employed, or a CWS of 31 when CAPC value 3 or 4 is employed, and so on.

In some examples, the set of CWS values may include all allowed CWS values for all allowed CAPC values, e.g., {3, 7, 15, 31, 63, 127, 255, 511, 1023} according to Table 1. Indicator #B1 may indicate one value among the set of CWS values. The size of indicator #B1 may be 4 bits (i.e., ┌log₂ 9┐) so as to indicate one of the 9 CWS values.

In some embodiments of the present disclosure, the BS may assign slot #n for a plurality of UEs (e.g., UE #B1 and UE #B1′) for sidelink transmissions. For example, the BS may schedule slot #n via separate DCIs or configured grants for UE #B1 and UE #B1′ to perform sidelink transmissions on the channel (e.g., via FDM). The BS may determine the maximum channel access duration among the plurality of UEs and leave one or more time units (e.g., a number of symbols or slots) preceding slot #n blank based on the maximum channel access duration, so as to ensure that the plurality of UEs may access slot #n. For example, each of UE #B1 and UE #B1′ may report a CWS (e.g., via indicator #B1) to the BS. The BS may determine corresponding channel access durations based on the reported CWSs, and determine the maximum channel access duration among the determined channel access durations. The one or more time units may be within or not shorter than the maximum channel access duration.

For example, in some embodiments of the present disclosure, when resource allocation mode 2 is employed, a UE (e.g., a Tx UE, denoted as UE #C1 for simplicity) may transmit information associated with a channel access procedure to be performed by UE #C1 to another UE (denoted as UE #C2 for simplicity). For example, when UE #C1 intends to reserve a slot (e.g., slot #n) for a sidelink transmission over an unlicensed spectrum, a (possible) channel access duration (e.g., channel access duration 415 in FIG. 4) which may be required for accessing the channel in the reserved slot is indicated. For example, UE #C1 may transmit an indicator (denoted as indicator #C1 for simplicity) indicating the channel access duration to, for example, UE #C2.

In some embodiments, indicator #C1 may be transmitted via the SCI format for reserving slot #n. In some embodiments, indicator #C1 may be transmitted via an MAC CE carried by the PSSCH scheduled by the SCI format. For example, a field in the SCI format or MAC CE may specify or include indicator #C1.

Various methods may be employed for implementing indicator #C1.

For example, indicator #C1 may indicate a value of the channel access duration from a set of channel access duration values. The size of indicator #C1 (e.g., the number of bits for indicator #C1) may be dependent on the number of values in the set of channel access duration values. For example, the size of indicator #C1 may be equal to ┌log₂ N′┐, where N′ is the number of values in the set of channel access duration values.

The set of channel access duration values may be in units of microseconds, symbols or slots. For example, the set of channel access duration values may be {25 us, 34 us, 43 us, 52 us, 61 us, 70 us, 100 us, 140 us, 210 us, . . . }, {0 symbol, 1 symbol, 2 symbols, 4 symbols, 7 symbols, . . . }, or {0 slot, 1 slot, 2 slots, 4 slots, . . . }. Indicator #C1 may indicate one value among the set of channel access duration values.

In some embodiments, when another UE (e.g., UE #C2) intends to use or reserve one or more consecutive slots preceding the slot (e.g., slot #n) reserved by UE #C1 or include the one or more consecutive slots into its candidate resource set, UE #C2 may determine whether to use or reserve the one or more consecutive slots preceding slot #n or whether to include the one or more consecutive slots preceding slot #n in the candidate resource set based on the indicated channel access duration required by UE #C1 (e.g., indicated by indicator #C1). For example, UE #C2 may determine whether the one or more consecutive slots preceding slot #n are within the indicated channel access duration. For example, UE #C2 may determine whether to use or reserve the one or more consecutive slots or include the one or more consecutive slots in the candidate resource set based on whether the one or more consecutive slots are included in the range of the indicated channel access duration for accessing slot #n. For example, UE #C2 may leave one or more symbols or slots preceding slot #n not shorter than the indicated channel access duration blank to ensure that UE #C1 may access slot #n.

For simplicity, it is assumed that a slot includes 14 symbols and a slot is not used for sidelink transmission if the number of available symbols in this slot is smaller than 6 in the context of the present disclosure.

For example, in the case that the indicated channel access duration is confined within one symbol, UE #C2 can use or reserve slot #n−1 or include slot #n−1 into the candidate resource set. For example, in the case that the indicated channel access duration is larger than one symbol and smaller than or equal to 8 symbols, UE #C2 can use or reserve slot #n−1 or include slot #n−1 into the candidate resource set. For example, in the case that the indicated channel access duration is larger than 8 symbols and smaller than one slot, UE #C2 does not use or reserve slot #n−1 or include slot #n−1 into the candidate resource set, but can use or reserve slot #n−2 or include slot #n−2 into the candidate resource set. For example, in the case that the indicated channel access duration is larger than one or multiple consecutive slots, UE #C2 may not use or reserve the one or multiple consecutive slots preceding slot #n or include the one or multiple consecutive slots into the candidate resource set. For the first slot (i.e., earliest in the time domain) of these one or multiple consecutive slots preceding slot #n, if the number of symbols fully included in the range of the indicated channel access duration is larger than 8, UE #C2 does not use or reserve the first slot or include the first slot into the candidate resource set (let alone the slot(s) following this first slot); otherwise, UE #C2 can use or reserve the first slot or include the first slot into the candidate resource set.

In some embodiments of the present disclosure, a plurality of UEs (e.g., UE #C1 and UE #C1′) may reserve the same slot (e.g., slot #n) for sidelink transmissions. For example, UE #C1 and UE #C1′ may transmit respective SCI formats for reserving slot #n to perform sidelink transmissions on the channel (e.g., via FDM). Another UE (e.g., UE #C2) may determine the maximum channel access duration among the plurality of UEs and determine whether to include one or more consecutive slots preceding slot #n in a candidate resource set for a sidelink transmission associated with the another UE (e.g., UE #C2) based on the maximum channel access duration.

For example, each of UE #C1 and UE #C1′ may indicate a channel access duration (e.g., via indicator #C1). UE #C2 may determine the maximum channel access duration among the indicated channel access durations. UE #C2 may determine whether one or more consecutive slots preceding slot #n are within the maximum channel access duration. For example, similarly to the methods as described above, UE #C2 may not include a slot preceding slot #n in its candidate resource set when more than 8 symbols of this slot is within the maximum channel access duration preceding slot #n.

The above-described (possible) channel access duration (e.g., indicated by indicator #C1) can also be used by UE #C1 for resource selection. For example, referring to FIG. 3, it is assumed that UE #C1 intends to initiate a COT on a channel since slot #n+1. UE #C1 can determine a (possible) channel access duration required for accessing the channel and determine its candidate resource set based on the required channel access duration. For example, UE #C1 may not include a slot following slot #n in its candidate resource set when more than 8 symbols of the slot is within the required channel access duration.

For example, in the case that the required channel access duration is smaller than or equal to 8 symbols, UE #C1 can include slot #n+1 in its candidate resource set. For example, in the case that the required channel access duration is larger than 8 symbols, UE #C1 does not include slot #n+1 in its candidate resource set. For example, in the case that the required channel access duration is larger than 8 symbols but smaller than or equal to 22 symbols, UE #C1 can include slot #n+2 in its candidate resource set. For example, in the case that the required channel access duration is larger than 22 symbols, UE #C1 does not include slot #n+1 and slot #n+2 in its candidate resource set.

For example, in some embodiments of the present disclosure, when resource allocation mode 2 is employed, a UE (e.g., a Tx UE, denoted as UE #D1 for simplicity) may transmit information associated with a channel access procedure to be performed by UE #D1 to another UE (denoted as UE #D2 for simplicity). For example, when UE #D1 intends to reserve a slot (e.g., slot #n) for a sidelink transmission over an unlicensed spectrum, a CWS (i.e., assuming that Type-1 channel access procedure is to be performed) which is to be used for accessing the channel in the reserved slot is indicated. The indicated CWS is to be used for generating a random backoff counter for Type-1 channel access procedure for accessing the channel in the reserved slot. For example, UE #D1 may transmit an indicator (denoted as indicator #D1 for simplicity) indicating the CWS to, for example, UE #D2. As will be described in details in the following text, in some embodiments, indicator #D1 can be used to indicate that a Type-2 channel access procedure is to be performed.

In some embodiments, indicator #D1 may be transmitted via the SCI format for reserving slot #n. In some embodiments, indicator #D1 may be transmitted via an MAC CE carried by the PSSCH scheduled by the SCI format. For example, a field in the SCI format or MAC CE may specify or include indicator #D1.

Various methods may be employed for implementing indicator #D1.

In some embodiments of the present disclosure, indicator #D1 may indicate a value of the CWS from a set of CWS values. In some embodiments, the set of CWS values may include all allowed CWS values for a CAPC value associated with the channel access procedure. In some embodiments, the size of indicator #D1 (e.g., the number of bits for indicator #D1) may be dependent on the number of values in the set of CWS values. For example, the size of indicator #D1 may be equal to ┌log₂ K′┐, where K′ is the number of values in the set of CWS values.

For example, based on Table 1, Table 2 below further shows the number of required bits for indicating a CWS (e.g., the size of indicator #D1). It should be understood that Table 2 is only for illustrative purposes, and should not be construed as limiting the embodiments of the present disclosure.

TABLE 2
Number of required bits for indicating CWS

| | | Number of | |
|---|---|---|---|
| | | required | |
| | | bits for | |
| | | indicating | |
| CAPC (p) | allowed CWₚ sizes | CWₚ size | Examples |
| 1 | {3, 7} | 1 bit | Bit 0: CWS of 3, |
| | | | Bit 1: CWS of 7 |
| 2 | {7, 15} | 1 bit | Bit 0: CWS of 7, |
| | | | Bit 1: CWS of 15 |
| 3 | {15, 31, 63, 127, 255, | 3 bits | 3 bits correspond to |
| | 511, 1023} | | one of the 7 CW sizes |
| 4 | {15, 31, 63, 127, 255, | 3 bits | 3 bits correspond to |
| | 511, 1023} | | one of the 7 CW sizes |

As can be seen in Table 2, the number of required bits for indicating the CWS (e.g., the size of indicator #D1) can be variable according to the CAPC value associated with the channel access procedure to be performed.

In some embodiments, the size of indicator #D1 (e.g., the number of bits for indicator #D1) may be dependent on the maximum number of allowed CWS values for each allowed CAPC value (which is max (2, 2, 7, 7)=7 in the examples of Tables 1 and 2). For example, the size of indicator #D1 may always be 3 bits (i.e., ┌log₂ max (2, 2, 7, 7)┐) regardless of the CAPC value associated with the channel access procedure to be performed. For example, indicator #D1 may include 3 bit, where bit value “000” may indicate a CWS of 3 when CAPC value 1 is employed, a CWS of 7 when CAPC value 2 is employed, or a CWS of 15 when CAPC value 3 or 4 is employed; bit value “001” may indicate a CWS of 7 when CAPC value 1 is employed, a CWS of 15 when CAPC value 2 is employed, or a CWS of 31 when CAPC value 3 or 4 is employed, and so on.

In some embodiments, UE #D1 may further indicate the CAPC value associated with the channel access procedure or a priority associated with the sidelink transmission to UE #D2 (e.g., in the SCI or MAC CE which includes indicator #D1). UE #D2 can use the indicated CAPC value or priority and indicator #D1 to determine the CWS to be used for accessing the channel in the reserved slot. For example, referring to Table 2, in the case that the size of indicator #D1 is 1 bit, when the indicated CAPC value is 1, the value of indicator #D1 being “0” indicates a CWS of 3 and the value of indicator #D1 being “1” indicates a CWS of 7.

In some embodiments of the present disclosure, indicator #D1 may indicate a value of the CWS from a set of CWS values (or a CWS table). In some embodiments, the set of CWS values may include all allowed CWS values for all allowed CAPC values. The set of CWS values can also be referred to as a CWS table with a plurality of entries, and each entry indicates a CWS value. The CWS indicated by indicator #D1 is the CWS to be used for performing a Type-1 channel access procedure for accessing the reserved slot.

The size of indicator #D1 may be dependent on the number of values in the set of CWS values. For example, referring to Table 1, a total of 9 CWSs, i.e., {3, 7, 15, 31, 63, 127, 255, 511, 1023} is supported. Therefore, 4 bits (i.e., ┌log₂ 9┐) would be sufficient to indicate one of the 9 CWSs. For example, the size of indicator #D1 may be 4 bits. Since the CWS is only applicable for a Type-1 channel access procedure, in some embodiments, a codepoint of indicator #D1 can be used to indicate that a Type-2 channel access procedure is to be performed for accessing the reserved slot.

An example CWS table is shown in Table 3. It should be understood that Table 3 is only for illustrative purposes, and should not be construed as limiting the embodiments of the present disclosure.

TABLE 3
CWS table

| Entry index | Indicated CWp size |
|---|---|
| 0 | — |
| 1 | 3 |
| 2 | 7 |
| 3 | 15 |
| 4 | 31 |
| 5 | 63 |
| 6 | 127 |
| 7 | 255 |
| 8 | 511 |
| 9 | 1023 |

According to Table 3, when indicator #D1 points to entry index “0” (e.g., the value of indicator #D1 is “0000”), it suggests that the channel access procedure to be performed by UE #D1 is a Type-2 channel access procedure. When indicator #D1 points to one of entry indexes “1” to “9” (e.g., the value of indicator #D1 is one of “0001” to “1001”), the channel access procedure to be performed by UE #D1 is a Type-1 channel access procedure and the corresponding CWS is indicated.

In some embodiments, when indicator #D1 indicates an inapplicable CWS value (e.g., a negative value such as “−1”), it suggests that the channel access procedure to be performed by UE #D1 is a Type-2 channel access procedure. When indicator #D1 indicates an applicable CWS value, the channel access procedure to be performed by UE #D1 is a Type-1 channel access procedure. For example, the set of CWS values may be {−1, 3, 7, 15, 31, 63, 127, 255, 511, 1023}.

In some embodiments of the present disclosure, indicator #D1 may indicate an entry of a table (also referred to as “channel access information table” for clarity), and each entry of the table indicates a channel access type associated with the channel access procedure. Such table can be predefined, for example, in a standard(s) or configured by, for example, RRC signaling. In some embodiments, each entry of the table may include addition information associated with the channel access procedure, including for example, the cyclic prefix extension (CPE) information associated with the channel access procedure. In some embodiments, for each entry of the table which indicates a Type-1 channel access procedure, the corresponding entry may include addition information associated with the Type-1 channel access procedure, including for example, the CAPC value associated with the Type-1 channel access procedure or both the CAPC value and the CWS associated with the Type-1 channel access procedure.

For example, in some embodiments, indicator #D1 may jointly indicate the channel access type, CAPC, CWS, and CPE information associated with the channel access procedure, wherein the CAPC and CWS are indicated when the channel access type is a Type-1 channel access procedure. The indicated CWS is the CWS to be used for performing a Type-1 channel access procedure for accessing the reserved slot. For example, indicator #D1 may indicate an entry of a channel access information table which includes a plurality of entries with each entry including a channel access type and the CPE information as well as the CAPC and CWS when the channel access type is the Type-1 channel access procedure. For example, the CAPCs and the CWSs in the channel access information table may be selected from Table 1. In some embodiments, each CAPC value in the channel access information table may be associated with one or more (allowed) CWSs for a corresponding CAPC value in the table.

An example channel access information table is shown in Table 4. Indicator #D1 may indicate an entry of Table 4. It should be understood that Table 4 is only for illustrative purposes, and should not be construed as limiting the embodiments of the present disclosure. For example, a channel access information table including only a subset of entries of Table 4 may be configured for a UE or predefined, for example, in a standard(s).

TABLE 4
joint indication of CAPC, CWS, channel access type and CPE

| Entry index | Channel access type | CAPC (p) | CWp size | CPE |
|---|---|---|---|---|
| 0 | Type 2 | — | — | 0 |
| 1 | Type 2 | — | — | 1 |
| 2 | Type 2 | — | — | 2 |
| 3 | Type 2 | — | — | 3 |
| 4 | Type 1 | 1 | 3 | 0 |
| 5 | Type 1 | 1 | 7 | 0 |
| 6 | Type 1 | 2 | 7 | 0 |
| 7 | Type 1 | 2 | 15 | 0 |
| 8 | Type 1 | 3 | 15 | 0 |
| 9 | Type 1 | 3 | 31 | 0 |
| 10 | Type 1 | 3 | 63 | 0 |
| 11 | Type 1 | 3 | 127 | 0 |
| 12 | Type 1 | 3 | 255 | 0 |
| 13 | Type 1 | 3 | 511 | 0 |
| 14 | Type 1 | 3 | 1023 | 0 |
| 15 | Type 1 | 4 | 15 | 0 |
| 16 | Type 1 | 4 | 31 | 0 |
| 17 | Type 1 | 4 | 63 | 0 |
| 18 | Type 1 | 4 | 127 | 0 |
| 19 | Type 1 | 4 | 255 | 0 |
| 20 | Type 1 | 4 | 511 | 0 |
| 21 | Type 1 | 4 | 1023 | 0 |
| 22 | Type 1 | 1 | 3 | 1 |
| 23 | Type 1 | 1 | 7 | 1 |
| 24 | Type 1 | 2 | 7 | 1 |
| 25 | Type 1 | 2 | 15 | 1 |
| 26 | Type 1 | 3 | 15 | 1 |
| 27 | Type 1 | 3 | 31 | 1 |
| 28 | Type 1 | 3 | 63 | 1 |
| 29 | Type 1 | 3 | 127 | 1 |
| 30 | Type 1 | 3 | 255 | 1 |
| 31 | Type 1 | 3 | 511 | 1 |
| 32 | Type 1 | 3 | 1023 | 1 |
| 33 | Type 1 | 4 | 15 | 1 |
| 34 | Type 1 | 4 | 31 | 1 |
| 35 | Type 1 | 4 | 63 | 1 |
| 36 | Type 1 | 4 | 127 | 1 |
| 37 | Type 1 | 4 | 255 | 1 |
| 38 | Type 1 | 4 | 511 | 1 |
| 39 | Type 1 | 4 | 1023 | 1 |
| 40 | Type 1 | 1 | 3 | 2 |
| 41 | Type 1 | 1 | 7 | 2 |
| 42 | Type 1 | 2 | 7 | 2 |
| 43 | Type 1 | 2 | 15 | 2 |
| 44 | Type 1 | 3 | 15 | 2 |
| 45 | Type 1 | 3 | 31 | 2 |
| 46 | Type 1 | 3 | 63 | 2 |
| 47 | Type 1 | 3 | 127 | 2 |
| 48 | Type 1 | 3 | 255 | 2 |
| 49 | Type 1 | 3 | 511 | 2 |
| 50 | Type 1 | 3 | 1023 | 2 |
| 51 | Type 1 | 4 | 15 | 2 |
| 52 | Type 1 | 4 | 31 | 2 |
| 53 | Type 1 | 4 | 63 | 2 |
| 54 | Type 1 | 4 | 127 | 2 |
| 55 | Type 1 | 4 | 255 | 2 |
| 56 | Type 1 | 4 | 511 | 2 |
| 57 | Type 1 | 4 | 1023 | 2 |
| 58 | Type 1 | 1 | 3 | 3 |
| 59 | Type 1 | 1 | 7 | 3 |
| 60 | Type 1 | 2 | 7 | 3 |
| 61 | Type 1 | 2 | 15 | 3 |
| 62 | Type 1 | 3 | 15 | 3 |
| 63 | Type 1 | 3 | 31 | 3 |
| 64 | Type 1 | 3 | 63 | 3 |
| 65 | Type 1 | 3 | 127 | 3 |
| 66 | Type 1 | 3 | 255 | 3 |
| 67 | Type 1 | 3 | 511 | 3 |
| 68 | Type 1 | 3 | 1023 | 3 |
| 69 | Type 1 | 4 | 15 | 3 |
| 70 | Type 1 | 4 | 31 | 3 |
| 71 | Type 1 | 4 | 63 | 3 |
| 72 | Type 1 | 4 | 127 | 3 |
| 73 | Type 1 | 4 | 255 | 3 |
| 74 | Type 1 | 4 | 511 | 3 |
| 75 | Type 1 | 4 | 1023 | 3 |

For example, in some embodiments, indicator #D1 may jointly indicate the channel access type, CAPC, a single CWS per CAPC value, and CPE information associated with the channel access procedure, wherein the CAPC and CWS are indicated when the channel access type is a Type-1 channel access procedure. The indicated CWS is the CWS to be used for performing a Type-1 channel access procedure for accessing the reserved slot. For example, indicator #D1 may indicate an entry of a channel access information table which includes a plurality of entries with each entry including a channel access type and the CPE information as well as the CAPC or both the CAPC and CWS when the channel access type is the Type-1 channel access procedure, wherein each CAPC value in the channel access information table may be associated with a single CWS.

In some examples, the single CWS may be included in the channel access information table. For example, referring to Table 1, a CAPC value may correspond to a plurality of CWSs. The single CWS may be determined based on the allowed CWSs for a corresponding CAPC value. For example, the single CWS may be the minimum CWS, maximum CWS, or an average CWS among all allowed CWSs for a corresponding CAPC value. For example, the single CWS may be a reference CWS, which can be configured by RRC signaling or predefined, for example, in standard. For example, for each allowed CAPC value, a corresponding reference CWS may be configured or predefined. To a certain extent, the minimum CWS, maximum CWS, and the average CWS can be seen as examples of reference CWS.

In some other examples, the channel access information table may not include the single CWS. For example, based on the CAPC value indicated by indicator #D1 and Table 1, the minimum CWS, maximum CWS, or the average CWS for the indicated CAPC value can be determined. For example, based on the CAPC value indicated by indicator #D1 and the configured or predefined set of reference CWSs, the corresponding reference CWS for the indicated CAPC value can be determined.

An example channel access information table is shown in Table 5, in which average CWSs among all allowed CWSs for a corresponding CAPC value are indicated. For example, the average CWS 5 in entry “4” is an average of CWS 3 and CWS 7, which correspond to CAPC value 1 as shown in Table 1. Indicator #D1 may indicate an entry of Table 5.

TABLE 5
joint indication of CAPC, channel
access type, CPE and average CWS

| | Channel access | | | |
|---|---|---|---|---|
| Entry index | type | CAPC (p) | Average CWp size | CPE |
| 0 | Type 2 | — | — | 0 |
| 1 | Type 2 | — | — | 1 |
| 2 | Type 2 | — | — | 2 |
| 3 | Type 2 | — | — | 3 |
| 4 | Type 1 | 1 | 5 | 0 |
| 5 | Type 1 | 1 | 5 | 1 |
| 6 | Type 1 | 1 | 5 | 2 |
| 7 | Type 1 | 1 | 5 | 3 |
| 8 | Type 1 | 2 | 11 | 0 |
| 9 | Type 1 | 2 | 11 | 1 |
| 10 | Type 1 | 2 | 11 | 2 |
| 11 | Type 1 | 2 | 11 | 3 |
| 12 | Type 1 | 3 | 55 | 0 |
| 13 | Type 1 | 3 | 55 | 1 |
| 14 | Type 1 | 3 | 55 | 2 |
| 15 | Type 1 | 3 | 55 | 3 |
| 16 | Type 1 | 4 | 167 | 0 |
| 17 | Type 1 | 4 | 167 | 1 |
| 18 | Type 1 | 4 | 167 | 2 |
| 19 | Type 1 | 4 | 167 | 3 |

It should be understood that Table 5 is only for illustrative purposes, and should not be construed as limiting the embodiments of the present disclosure. For example, a channel access information table including only a subset of entries of Table 5 may be configured for a UE or predefined, for example, in a standard(s). For example, instead of indicating the average CWSs, the reference CWS, the minimum CWSs or maximum CWSs may be indicated. For example, instead of indicating the average CWSs, no CWS may be indicated.

For example, in some embodiments, indicator #D1 may jointly indicate the channel access type, CAPC, and CWS associated with the channel access procedure, wherein the CAPC and CWS are indicated when the channel access type is a Type-1 channel access procedure. The indicated CWS is the CWS to be used for performing a Type-1 channel access procedure for accessing the reserved slot. For example, indicator #D1 may indicate an entry of a channel access information table which includes a plurality of entries with each entry including a channel access type as well as the CAPC and CWS when the channel access type is the Type-1 channel access procedure. For example, one entry of the channel access information table is reserved for a Type-2 channel access procedure for accessing the reserved slot. That is, the table includes one entry indicating a Type-2 channel access procedure without the CAPC and CWS information.

For example, a table similar to Table 4 or Table 5 (with the removal of the CPE information from Table 4 and Table 5) may be used as the channel access information table. For example, in some embodiments, each CAPC value in the table may be associated with one or more (allowed) CWSs for a corresponding CAPC value in the table. For example, in some embodiments, each CAPC value in the table may be associated with a single CWS.

An example channel access information table is shown in Table 6. Indicator #D1 may indicate an entry of Table 6. It should be understood that Table 6 is only for illustrative purposes, and should not be construed as limiting the embodiments of the present disclosure. For example, a table including only a subset of entries of Table 6 may be configured for a UE or predefined, for example, in a standard(s).

TABLE 6
joint indication of CAPC, channel access type and CWS

| Entry index | Channel access type | CAPC (p) | CWp size |
|---|---|---|---|
| 0 | Type 2 | — | — |
| 1 | Type 1 | 1 | 3 |
| 2 | Type 1 | 1 | 7 |
| 3 | Type 1 | 2 | 7 |
| 4 | Type 1 | 2 | 15 |
| 5 | Type 1 | 3 | 15 |
| 6 | Type 1 | 3 | 31 |
| 7 | Type 1 | 3 | 63 |
| 8 | Type 1 | 3 | 127 |
| 9 | Type 1 | 3 | 255 |
| 10 | Type 1 | 3 | 511 |
| 11 | Type 1 | 3 | 1023 |
| 12 | Type 1 | 4 | 15 |
| 13 | Type 1 | 4 | 31 |
| 14 | Type 1 | 4 | 63 |
| 15 | Type 1 | 4 | 127 |
| 16 | Type 1 | 4 | 255 |
| 17 | Type 1 | 4 | 511 |
| 18 | Type 1 | 4 | 1023 |

In some embodiments, the CAPC values in the above embodiments (e.g., Tables 4-6) can be replaced by priorities of the sidelink transmission.

In some embodiments, when another UE (e.g., UE #D2) intends to use or reserve one or more consecutive slots preceding the slot (e.g., slot #n) reserved by UE #D1 or include the one or more consecutive slots into its candidate resource set, UE #D2 may determine whether to use or reserve the one or more consecutive slots preceding slot #n or whether to include the one or more consecutive slots preceding slot #n in the candidate resource set based on indicator #D1 (e.g., the indicated CWS) transmitted by UE #D1. For example, UE #D2 may estimate a (possible) channel access duration based on indicator #D1, and determine whether the one or multiple consecutive slots preceding slot #n are within the estimated channel access duration. For example, UE #D2 may determine whether to use or reserve the one or more consecutive slots or include the one or more consecutive slots in the candidate resource set based on whether the one or more consecutive slots are included in the range of the estimated channel access duration for accessing slot #n. For example, UE #D2 may leave one or more symbols or slots preceding slot #n not shorter than the indicated channel access duration blank to ensure that UE #D1 may access slot #n.

In some embodiments, when a Type-2 channel access procedure is indicated by UE #D1 (e.g., indicated by indicator #D1), UE #D2 may determine the channel access duration required by UE #D1 based on the sensing interval of a Type-2 channel access procedure (e.g., >=25 us, =16 us, or <16 us). UE #D2 can use or reserve one or more slots (e.g., slot #n−1) preceding slot #n (i.e., the slot reserved by UE #D1), or include the one or more slots into its candidate resource set. UE #D2 may leave at least one symbol at the end of slot #n−1 as a gap for UE #D1 to perform a Type-2 channel access procedure for accessing the channel in slot #n.

In some embodiments, when a Type-1 channel access procedure is indicated by UE #D1 (e.g., indicated by indicator #D1), UE #D2 may determine the (possible) channel access duration required by UE #D1 based on the indicated CWS and other necessary information (e.g., the CAPC or the priority associated with the channel access procedure, which may also be indicated by indicator #D1). For example, UE #D2 may estimate the channel access duration required by UE #D1 based on the equation of (16+mₚ*9+9*M) in unit of microseconds, where M=CWS, M=┌CWS/2┐ or M=┌CWS/2┐ and CWS is indicated by UE #D1 (e.g., as indicated by indicator #D1), and mₚ is based on the indicated CAPC. As described above, the CWS is indicated by UE #D1 or indicator #D1 and can be one of the allowed CWSs corresponding to the CAPC associated with the channel access procedure, the average CWS, the minimum CWS, the maximum CWS, or the reference CWS.

In some embodiments, UE #D1 or indicator #D1 may not indicate the CWS, but may indicate the CAPC or the priority associated with the channel access procedure. In the these embodiments, in the above equation for determining the channel access duration, M may be the average CWS, the minimum CWS, the maximum CWS, or the reference CWS (i.e., M=CW_{average}, M=CWₘᵢₙ, M=CWₘₐₓ, or M=CW_{ref}), which can be determined based on the indicated CAPC or priority.

For example, in the case that the estimated channel access duration is confined within one symbol, UE #D2 can use or reserve slot #n−1 or include slot #n−1 into its candidate resource set. For example, in the case that the estimated channel access duration is larger than one symbol and smaller than or equal to 8 symbols, UE #D2 can use or reserve slot #n−1 or include slot #n−1 into the candidate resource set. For example, in the case that the estimated channel access duration is larger than 8 symbols and smaller than one slot, UE #D2 does not use or reserve slot #n−1 or include slot #n−1 into the candidate resource set, but can use or reserve slot #n−2 or include slot #n−2 into the candidate resource set. For example, in the case that the estimated channel access duration is larger than one or multiple consecutive slots, UE #D2 may not use or reserve the one or multiple consecutive slots preceding slot #n or include the one or multiple consecutive slots into the candidate resource set. For the first slot (i.e., earliest in the time domain) of these one or multiple consecutive slots preceding slot #n, if the number of symbols fully included in the range of the estimated channel access duration is larger than 8, UE #D2 does not use or reserve the first slot or include the first slot into the candidate resource set (let alone the slot(s) following this first slot); otherwise, UE #D2 can use or reserve the first slot or include the first slot into the candidate resource set.

In some embodiments of the present disclosure, a plurality of UEs (e.g., UE #D1 and UE #D1′) may reserve the same slot (e.g., slot #n) for sidelink transmissions. For example, UE #D1 and UE #D1′ may transmit respective SCI formats for reserving slot #n to perform sidelink transmissions on the channel (e.g., via FDM). Another UE (e.g., UE #D2) may determine the maximum channel access duration among the plurality of UEs and determine whether to include one or more consecutive slots preceding slot #n in a candidate resource set for a sidelink transmission associated with the another UE (e.g., UE #D2) based on the maximum channel access duration.

For example, each of UE #D1 and UE #D1′ may indicate a CWS (e.g., via indicator #D1). UE #D2 may determine corresponding channel access durations based on the reported CWSs, and determine the maximum channel access duration among the determined channel access durations. UE #D2 may determine whether one or more consecutive slots preceding slot #n are within the maximum channel access duration. For example, similarly to the methods as described above, UE #D2 may not include a slot preceding slot #n in its candidate resource set when more than 8 symbols of this slot is within the maximum channel access duration preceding slot #n.

The above-described CWS (e.g., indicated by indicator #D1) can also be used by UE #D1 for resource selection. For example, as described above, referring to FIG. 3, it is assumed that UE #D1 intends to initiate a COT on a channel since slot #n+1. UE #D1 can determine a channel access duration required for accessing the channel (e.g., based on the CWS) and determine its candidate resource set based on the determined channel access duration. For example, UE #D1 may not include a slot following slot #n in its candidate resource set when more than 8 symbols of the slot is within the required channel access duration.

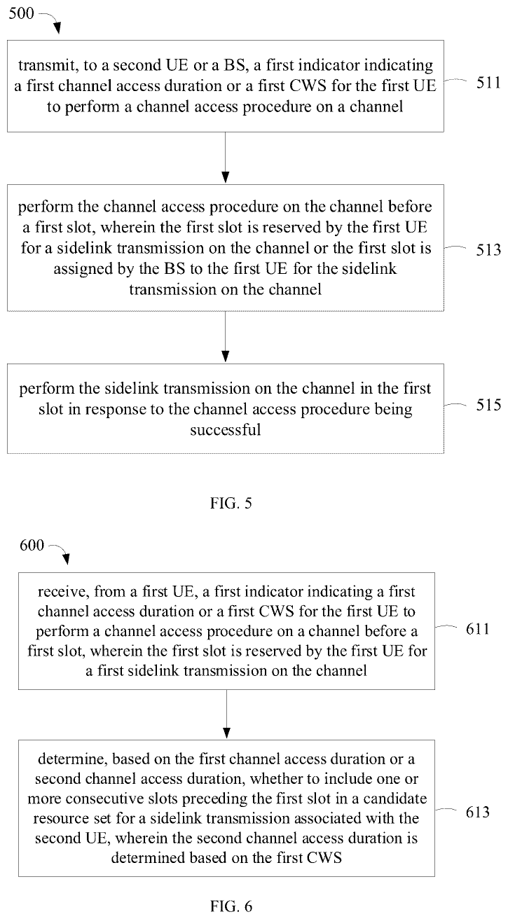

FIG. 5 illustrates a flow chart of exemplary procedure 500 for sidelink communications in accordance with some embodiments of the present disclosure. Details described in all of the foregoing embodiments of the present disclosure are applicable for the embodiments shown in FIG. 5. In some examples, the procedure may be performed by a UE, for example, UE 110 in FIG. 1.

Referring to FIG. 5, in operation 511, a first UE may transmit, to a second UE or a BS, a first indicator indicating a first channel access duration or a first CWS for the first UE to perform a channel access procedure on a channel. For example, the first indicator may be one of indicator #A1 to indicator #D1.

In operation 513, the first UE may perform the channel access procedure on the channel before a first slot (e.g., slot #n as described above), wherein the first slot is reserved by the first UE for a sidelink transmission on the channel or the first slot is assigned by the BS to the first UE for the sidelink transmission on the channel. In operation 515, the first UE may perform the sidelink transmission on the channel in the first slot in response to the channel access procedure being successful.

In some embodiments of the present disclosure, the first indicator may indicate a value of the first channel access duration from a set of channel access duration values. In some embodiments of the present disclosure, the set of channel access duration values may be in units of microseconds, symbols or slots. In some embodiments of the present disclosure, a size of the first indicator may be dependent on the number of values in the set of channel access duration values. For example, the descriptions with respect to indicator #A1 and indicator #C1 may apply here.

In some embodiments of the present disclosure, the first indicator may indicate a value of the first CWS from a set of CWS values. In some embodiments, the set of CWS values may include all allowed CWS values for a CAPC value associated with the channel access procedure. In some embodiments, the set of CWS values may include all allowed CWS values for all allowed CAPC values. For example, the descriptions with respect to indicator #B1 and indicator #D1 may apply here.

For example, in some embodiments of the present disclosure, a size of the first indicator may be dependent on the number of values in the set of CWS values. In some embodiments of the present disclosure, a size of the first indicator may be dependent on a maximum number of allowed CWS values for each allowed CAPC value. In some embodiments of the present disclosure, the first indicator may be transmitted to the second UE. The first UE may transmit a second indicator indicating the CAPC value associated with the channel access procedure or a priority associated with the sidelink transmission.

In some embodiments of the present disclosure, the first indicator may be transmitted to the second UE via an SCI format for reserving the first slot. In some embodiments of the present disclosure, the first indicator may be transmitted to the second UE via an MAC CE carried by a PSSCH scheduled by the SCI format. For example, the descriptions with respect to indicator #C1 and indicator #D1 may apply here.

In some embodiments of the present disclosure, the first indicator may indicate a value of the first CWS from a set of CWS values, which includes all allowed CWS values for all allowed CAPC values. In some embodiments of the present disclosure, a codepoint of the first indicator may indicate that the channel access procedure to be performed by the first UE is a second type channel access procedure. In some embodiments of the present disclosure, in the case that the first indicator indicates an inapplicable CWS value, the channel access procedure to be performed by the first UE is a second type channel access procedure.

In some embodiments of the present disclosure, the first indicator may indicate an entry of a table, and each entry of the table may indicate a channel access type associated with the channel access procedure. For each entry indicating a first type channel access procedure, a corresponding entry may further indicate a CAPC value associated with the first type channel access procedure or both the CAPC value and a CWS associated with the first type channel access procedure.

In some embodiments of the present disclosure, each entry of the table may further indicate CPE information associated with the channel access procedure.

In some embodiments of the present disclosure, each CAPC value in the table may be associated with one or more allowed CWSs for a corresponding CAPC value in the table. In some embodiments of the present disclosure, each CAPC value in the table may be associated with a single CWS.

In some embodiments of the present disclosure, the single CWS may be a minimum CWS, maximum CWS, or an average CWS among all allowed CWSs for a corresponding CAPC value or a reference CWS for the corresponding CAPC value.

It should be appreciated by persons skilled in the art that the sequence of the operations in exemplary procedure 500 may be changed and some of the operations in exemplary procedure 500 may be eliminated or modified, without departing from the spirit and scope of the disclosure.

FIG. 6 illustrates a flow chart of exemplary procedure 600 for sidelink communications in accordance with some embodiments of the present disclosure. Details described in all of the foregoing embodiments of the present disclosure are applicable for the embodiments shown in FIG. 6. In some examples, the procedure may be performed by a UE, for example, UE 110 in FIG. 1.

Referring to FIG. 6, in operation 611, a second UE may receive, from a first UE, a first indicator indicating a first channel access duration or a first CWS for the first UE to perform a channel access procedure on a channel before a first slot, wherein the first slot is reserved by the first UE for a first sidelink transmission on the channel. For example, the first indicator may be one of indicator #C1 and indicator #D1.

In operation 613, the second UE may determine, based on the first channel access duration or a second channel access duration, whether to include one or more consecutive slots preceding the first slot in a candidate resource set for a sidelink transmission associated with the second UE, wherein the second channel access duration is determined based on the first CWS.

In some embodiments of the present disclosure, the first indicator may indicate a value of the first channel access duration from a set of channel access duration values. In some embodiments of the present disclosure, the set of channel access duration values may be in units of microseconds, symbols or slots. In some embodiments of the present disclosure, a size of the first indicator may be dependent on the number of values in the set of channel access duration values. For example, the descriptions with respect to indicator #C1 may apply here.

In some embodiments of the present disclosure, the first indicator may indicate a value of the first CWS from a set of CWS values, which may include all allowed CWS values for a channel access priority class (CAPC) value associated with the channel access procedure. For example, the descriptions with respect to indicator #D1 may apply here.

In some embodiments of the present disclosure, a size of the first indicator may be dependent on the number of values in the set of CWS values or a maximum number of allowed CWS values for each allowed CAPC value.

In some embodiments of the present disclosure, the second UE may further receive a second indicator indicating the CAPC value associated with the channel access procedure or a priority associated with the first sidelink transmission.

In some embodiments of the present disclosure, the first indicator may be received in an SCI format for reserving the first slot. In some embodiments of the present disclosure, the first indicator may be received in an MAC CE carried by a PSSCH scheduled by the SCI format. For example, the descriptions with respect to indicator #C1 and indicator #D1 may apply here.

In some embodiments of the present disclosure, the first indicator may indicate a value of the first CWS from a set of CWS values, which may include all allowed CWS values for all allowed CAPC values. In some embodiments of the present disclosure, a codepoint of the first indicator may indicate that the channel access procedure to be performed by the first UE is a second type channel access procedure. In some embodiments of the present disclosure, in the case that the first indicator indicates an inapplicable CWS value, the channel access procedure to be performed by the first UE is a second type channel access procedure.

In some embodiments of the present disclosure, the first indicator may indicate an entry of a table, and each entry of the table may indicate a channel access type associated with the channel access procedure. In some embodiments of the present disclosure, wherein for each entry indicating a first type channel access procedure, a corresponding entry may further indicate a CAPC value associated with the first type channel access procedure or both the CAPC value and a CWS associated with the first type channel access procedure.

In some embodiments of the present disclosure, each entry of the table may further indicate CPE information associated with the channel access procedure.

In some embodiments of the present disclosure, each CAPC value in the table may be associated with one or more allowed CWSs for a corresponding CAPC value in the table. In some embodiments of the present disclosure, each CAPC value in the table may be associated with a single CWS.

In some embodiments of the present disclosure, the single CWS may be a minimum CWS, maximum CWS, or an average CWS among all allowed CWSs for a corresponding CAPC value or a reference CWS for the corresponding CAPC value.

In some embodiments of the present disclosure, determining whether to include the one or more consecutive slots preceding the first slot in the candidate resource set may include determining whether the one or more consecutive slots preceding the first slot are within the first or second channel access duration preceding the first slot.

In some embodiments of the present disclosure, the second UE may receive, from a third UE, a third indicator indicating a third channel access duration or a second CWS for the third UE to perform a channel access procedure on the channel before the first slot, wherein the first slot is reserved by the third UE for a sidelink transmission on the channel. In some embodiments of the present disclosure, determining whether to include the one or more consecutive slots preceding the first slot in the candidate resource set may include determining whether the one or more consecutive slots preceding the first slot are within a maximum duration between the first channel access duration and the third channel access duration preceding the first slot. In some embodiments of the present disclosure, determining whether to include the one or more consecutive slots preceding the first slot in the candidate resource set may include determining whether the one or more consecutive slots preceding the first slot are within a maximum duration between the second channel access duration and a fourth channel access duration preceding the first slot, wherein the fourth channel access duration is determined based on the second CWS.

It should be appreciated by persons skilled in the art that the sequence of the operations in exemplary procedure 600 may be changed and some of the operations in exemplary procedure 600 may be eliminated or modified, without departing from the spirit and scope of the disclosure.

FIG. 7 illustrates a flow chart of exemplary procedure 700 for sidelink communications in accordance with some embodiments of the present disclosure. Details described in all of the foregoing embodiments of the present disclosure are applicable for the embodiments shown in FIG. 7. In some examples, the procedure may be performed by a BS, for example, BS 120 in FIG. 1.

Referring to FIG. 7, in operation 711, a BS may receive, from a first UE, a first indicator indicating a first channel access duration or a first CWS for the first UE to perform a channel access procedure on a channel. For example, the first indicator may be one of indicator #A1 and indicator #B1.

In operation 713, the BS may transmit, to the first UE, a first DCI scheduling a first slot for the first UE to perform a sidelink transmission on the channel. In some other embodiments, the BS may schedule the first slot for the first UE to perform the sidelink transmission via a configured grant. In operation 715, the BS may leave, based on the first channel access duration or a second channel access duration, one or more time units (e.g., one or more symbols or slots) preceding the first slot blank, wherein the second channel access duration is determined based on the first CWS.

In some embodiments of the present disclosure, the first indicator may indicate a value of the first channel access duration from a set of channel access duration values. For example, the descriptions with respect to indicator #A1 may apply here. In some embodiments of the present disclosure, the set of channel access duration values may be in units of microseconds, symbols or slots. In some embodiments of the present disclosure, a size of the first indicator may be dependent on the number of values in the set of channel access duration values.

In some embodiments of the present disclosure, the first indicator may indicate a value of the first CWS from a set of CWS values. For example, the descriptions with respect to indicator #B1 may apply here. In some embodiments of the present disclosure, the set of CWS values may include all allowed CWS values for a CAPC value associated with the channel access procedure. In some embodiments of the present disclosure, the set of CWS values may include all allowed CWS values for all allowed CAPC values. In some embodiments of the present disclosure, a size of the first indicator may be dependent on the number of values in the set of CWS values or a maximum number of allowed CWS values for each allowed CAPC value.

In some embodiments of the present disclosure, leaving the one or more time units preceding the first slot blank may include determining whether the one or more time units preceding the first slot are within the first or second channel access duration preceding the first slot.

In some embodiments of the present disclosure, the BS may: receive, from a third UE, a third indicator indicating a third channel access duration or a second CWS for the third UE to perform a channel access procedure on the channel, and transmit, to the third UE, a second DCI scheduling the first slot for the third UE to perform a sidelink transmission on the channel. In some other embodiments, the BS may schedule the first slot for the third UE to perform the sidelink transmission via a configured grant. In some embodiments of the present disclosure, leaving the one or more time units preceding the first slot blank may include determining whether the one or more time units preceding the first slot are within a maximum duration between the first channel access duration and the third channel access duration preceding the first slot. In some embodiments of the present disclosure, leaving the one or more time units preceding the first slot blank may include determining whether the one or more time units preceding the first slot are within a maximum duration between the second channel access duration and a fourth channel access duration preceding the first slot, wherein the fourth channel access duration is determined based on the second CWS.

It should be appreciated by persons skilled in the art that the sequence of the operations in exemplary procedure 700 may be changed and some of the operations in exemplary procedure 700 may be eliminated or modified, without departing from the spirit and scope of the disclosure.

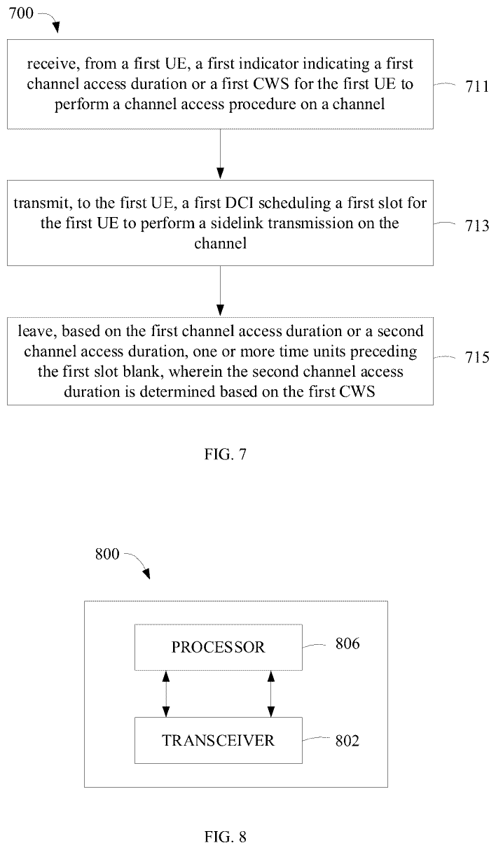

FIG. 8 illustrates a block diagram of an exemplary apparatus 800 according to some embodiments of the present disclosure. As shown in FIG. 8, the apparatus 800 may include at least one processor 806 and at least one transceiver 802 coupled to the processor 806. The apparatus 800 may be a UE or a BS.

Although in this figure, elements such as the at least one transceiver 802 and processor 806 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a UE. The transceiver 802 and the processor 806 may interact with each other so as to perform the operations with respect to the UEs described in FIGS. 1-7.

In some embodiments of the present application, the apparatus 800 may be a BS. The transceiver 802 and the processor 806 may interact with each other so as to perform the operations with respect to the BSs described in FIGS. 1-7.

In some embodiments of the present application, the apparatus 800 may further include at least one non-transitory computer-readable medium. For example, in some embodiments of the present disclosure, the non-transitory computer-readable medium may have stored thereon computer-executable instructions to cause the processor 806 to implement the methods with respect to the UEs as described above. For example, the computer-executable instructions, when executed, cause the processor 806 interacting with transceiver 802 to perform the operations with respect to the UEs described in FIGS. 1-7.

In some embodiments of the present application, the apparatus 800 may further include at least one non-transitory computer-readable medium. For example, in some embodiments of the present disclosure, the non-transitory computer-readable medium may have stored thereon computer-executable instructions to cause the processor 806 to implement the methods with respect to the BSs as described above. For example, the computer-executable instructions, when executed, cause the processor 806 interacting with transceiver 802 to perform the operations with respect to the BSs described in FIGS. 1-7.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

What is claimed is:

1. A first user equipment (UE), comprising:
at least one memory; and
at least one processor coupled with the at least one memory and operable to cause the first UE to:
transmit, to a second UE or a base station (BS), a first indicator indicating a first channel access duration or a first contention window size (CWS) for the first UE to perform a channel access procedure on a channel;
perform the channel access procedure on the channel before a first slot, wherein the first slot is reserved by the first UE for a sidelink transmission on the channel or the first slot is assigned by the BS to the first UE for the sidelink transmission on the channel; and
perform the sidelink transmission on the channel in the first slot in response to the channel access procedure being successful.

2. The first UE of claim 1, wherein the first indicator indicates a value of the first channel access duration from a set of channel access duration values.

3. The first UE of claim 1, wherein the first indicator indicates a value of the first CWS from a set of CWS values; and
wherein the set of CWS values includes all allowed CWS values for a channel access priority class (CAPC) value associated with the channel access 24 procedure, or includes all allowed CWS values for all allowed CAPC values.

4. The first UE of claim 3, wherein the first indicator is transmitted to the second UE, and the at least one processor is further operable to cause the first UE to transmit a second indicator indicating the CAPC value associated with the channel access procedure or a priority associated with the sidelink transmission.

5. The first UE of claim 1, wherein the first indicator is transmitted to the second UE via a sidelink control information (SCI) format for reserving the first slot; or
wherein the first indicator is transmitted to the second UE via a media access control (MAC) control element (CE) carried by a physical sidelink shared channel (PSSCH) scheduled by the SCI format.

6. The first UE of claim 1, wherein the first indicator indicates a value of the first CWS from a set of CWS values, which includes all allowed CWS values for all allowed channel access priority class (CAPC) values; and
wherein a codepoint of the first indicator indicates that the channel access procedure to be performed by the first UE comprises a second type channel access procedure, or
wherein in a case that the first indicator indicates an inapplicable CWS value, the channel access procedure to be performed by the first UE comprises a second type channel access procedure.

7. The first UE of claim 1, wherein the first indicator indicates an entry of a table, and each entry of the table indicates a channel access type associated with the channel access procedure; and
wherein for each entry indicating a first type channel access procedure, a corresponding entry further indicates a channel access priority class (CAPC) value associated with the first type channel access procedure or both the CAPC value and a CWS associated with the first type channel access procedure.

8. A second user equipment (UE), comprising:
at least one memory; and
at least one processor coupled with the at least one memory and operable to cause the second UE to:
receive, from a first UE, a first indicator indicating a first channel access duration or a first contention window size (CWS) for the first UE to perform a channel access procedure on a channel before a first slot, wherein the first slot is reserved by the first UE for a first sidelink transmission on the channel; and
determine, based on the first channel access duration or a second channel access duration, whether to include one or more consecutive slots preceding the first slot in a candidate resource set for a sidelink transmission associated with the second UE, wherein the second channel access duration is determined based on the first CWS.

9. The second UE of claim 8, wherein the first indicator indicates a value of the first channel access duration from a set of channel access duration values.

10. The second UE of claim 8, wherein the first indicator indicates a value of the first CWS from a set of CWS values, which includes all allowed CWS values for a channel access priority class (CAPC) value 1 associated with the channel access procedure.

11. The second UE of claim 8, wherein the first indicator is received in a sidelink control information (SCI) format for reserving the first slot; or
wherein the first indicator is received in a media access control (MAC) control element (CE) carried by a physical sidelink shared channel (PSSCH) scheduled by the SCI format.

12. The second UE of claim 8, wherein the first indicator indicates a value of the first CWS from a set of CWS values, which includes all allowed CWS values for all allowed channel access priority class (CAPC) values; and
wherein a codepoint of the first indicator indicates that the channel access procedure to be performed by the first UE is comprises a second type channel access procedure, or
wherein in a case that the first indicator indicates an inapplicable CWS value, the channel access procedure to be performed by the first UE comprises a second type channel access procedure.

13. The second UE of claim 8, wherein the first indicator indicates an entry of a table, and each entry of the table indicates a channel access type associated with the channel access procedure; and
wherein for each entry indicating a first type channel access procedure, a corresponding entry further indicates a channel access priority class (CAPC) value associated with the first type channel access procedure or both the CAPC value and a CWS associated with the first type channel access procedure.

14. The second UE of claim 8, wherein the at least one processor is operable to cause the second UE to receive, from a third UE, a third indicator indicating a third channel access duration or a second CWS for the third UE to perform a channel access procedure on the channel before the first slot, wherein the first slot is reserved by the third UE for a sidelink transmission on the channel; and
wherein determining whether to include the one or more consecutive slots preceding the first slot in the candidate resource set comprises:
determining whether the one or more consecutive slots preceding the first slot are within a maximum duration between the first channel access duration and the third channel access duration preceding the first slot; or
determining whether the one or more consecutive slots preceding the first slot are within a maximum duration between the second channel access duration and a fourth channel access duration preceding the first slot, wherein the fourth channel access duration is determined based on the second CWS.

15. A base station (BS), comprising:
at least one memory; and
at least one processor coupled with the at least one memory and operable to cause the BS to:
receive, from a first user equipment (UE), a first indicator indicating a first channel access duration or a first contention window size (CWS) for the first UE to perform a channel access procedure on a channel;
transmit, to the first UE, first downlink control information (DCI) scheduling a first slot for the first UE to perform a sidelink transmission on the channel; and
leave, based on the first channel access duration or a second channel access duration, one or more time units preceding the first slot blank, wherein the second channel access duration is determined based on the first CWS.

16. A method performed by a first user equipment (UE), the method comprising:
transmitting, to a second UE or a base station (BS), a first indicator indicating a first channel access duration or a first contention window size (CWS) for the first UE to perform a channel access procedure on a channel;
performing the channel access procedure on the channel before a first slot, wherein the first slot is reserved by the first UE for a sidelink transmission on the channel or the first slot is assigned by the BS to the first UE for the sidelink transmission on the channel; and
performing the sidelink transmission on the channel in the first slot in response to the channel access procedure being successful.

17. The method of claim 16, wherein the first indicator indicates a value of the first channel access duration from a set of channel access duration values.

18. The method of claim 16, wherein the first indicator indicates a value of the first CWS from a set of CWS values; and
wherein the set of CWS values includes all allowed CWS values for a channel access priority class (CAPC) value associated with the channel access procedure, or includes all allowed CWS values for all allowed CAPC values.

19. The method of claim 18, wherein the first indicator is transmitted to the second UE, and the method further comprises transmitting a second indicator indicating the CAPC value associated with the channel access procedure or a priority associated with the sidelink transmission.

20. The method of claim 16, wherein the first indicator is transmitted to the second UE via a sidelink control information (SCI) format for reserving the first slot; or
wherein the first indicator is transmitted to the second UE via a media access control (MAC) control element (CE) carried by a physical sidelink shared channel (PSSCH) scheduled by the SCI format.
